(19) United States
(12) Patent Application Publication
(10) Pub. No.: US 2010/0169757 A1
(43) Pub. Date: Jul. 1, 2010

(54) Filtering Method for Evaluating Patents

(76) Inventor: Adam Jude Ahne, Carbondale, IL (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/344,397

(22) Filed: Dec. 26, 2008

(51) Int. Cl. G06F 17/21; G06F 7/06; G06F 3/048; G06F 17/30

(52) U.S. Cl. 715/212; 715/234; 715/781; 715/854; 715/205; 707/E17.044; 707/E17.05; 707/E17.002

(57) ABSTRACT

A filtering method for evaluating patents comprises loading each unit of text or figure in a portfolio of patents into digital memory then comparing each unit of text or figure with all other units of text or figures in digital memory using digital data processing. The duplicate units of text or figures are determined and the earliest instance of each duplicate unit of text or figure is identified. The duplicate unit of text or figure, other than earliest instance, are marked as duplicate to create a filtered version of each patent in portfolio. The filtered version of each patent in portfolio is evaluated to determine the uniqueness of the patent specification and the interrelationships between the patents in the portfolio are determined. The interrelationships are illustrated in an electronic workspace for analyzing the portfolio of patents.

### CROSS REFERENCES TO RELATED APPLICATIONS

None.

### BACKGROUND

1. Field of the Invention

The present invention relates generally to a method of comparing units of text or figures in documents and, more particularly, to a method for filtering patents by comparing units of text or figures in order to evaluate patents in patent portfolio.

2. Description of the Related Art

It is often necessary for attorney and other intellectual property professionals to examine a group of related patents. For the purposes of this application, the term “patent” is meant to include both issued patents and patent applications. Such an examination can be made, for example, when evaluating the worth of a company's IP portfolio. This examination is usually quite time consuming, as thousands of patents may be involved spanning hundreds of thousands of pages of text. Much of the text is duplicated from patent to patent, as the text is boilerplate text, general background information, or text that first appeared in a parent or related application. For example, in an IP portfolio containing 3,500 patents, over two thirds of the text was duplicated. Therefore, a method of reducing the time required to analyze related patents is needed.

Method and means are generally well known in the prior art for locating in a stored textual database those textual blocks, which have the best match with a query as well as methods of measuring the similarity between units of text. These methods could be used in a method to filter patents and allow grouping of patents to show interrelationships.

### SUMMARY OF THE INVENTION

The present invention meets this need by filtering the patents in a company's IP portfolio by detecting duplicate units of text, such as paragraphs, that appear in more than one patent. Filtered versions of the patents can be generated in which the duplicate units of text are either marked or removed. Filtered versions will be shorter than originals and thus take less time to read, thereby reducing analysis time.

Accordingly, in an aspect of the present invention, a filtering method for evaluating patents comprises loading each unit of text in a portfolio of patents into digital memory then comparing each unit of text with all other units of text in digital memory using digital data processing. The duplicate units of text are determined and the earliest instance of each duplicate unit of text is identified. The duplicate unit of text, other than earliest instance, are marked as duplicate to create a filtered version of each patent in portfolio. The filtered version of each patent in portfolio is evaluated to determine the uniqueness of the patent specification and the interrelationships between the patents in the portfolio are determined. The interrelationships are illustrated in an electronic workspace for analyzing the portfolio of patents.

In another aspect of the present invention, a filtering method for evaluating patents comprises loading each figure in a portfolio of patents into digital memory then comparing each figure with all other figures in digital memory using digital data processing. The duplicate figures are determined and the earliest instance of each duplicate unit figure is identified. The duplicate figure, other than earliest instance, are marked as duplicates to create a filtered version of each patent in portfolio. The filtered version of each patent in portfolio is evaluated to determine the uniqueness of the patent specification and the interrelationships between the patents in the portfolio are determined. The interrelationships are illustrated in an electronic workspace for analyzing the portfolio of patents.

### BRIEF DESCRIPTION OF THE DRAWINGS

Having thus described the invention in general terms, reference will now be made to the accompanying drawings, which are not necessarily drawn to scale, and wherein:

FIG. 1 is a flowchart demonstrating the filtering method for units of text according to the present invention.

FIG. 2 is a flowchart demonstrating the filtering method for figures according to the present invention.

FIG. 3 is a sample graphical representation of a list of interrelated patents according to the present invention.

FIG. 4 is a sample electronic spreadsheet created using the filtering method according to the present invention.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

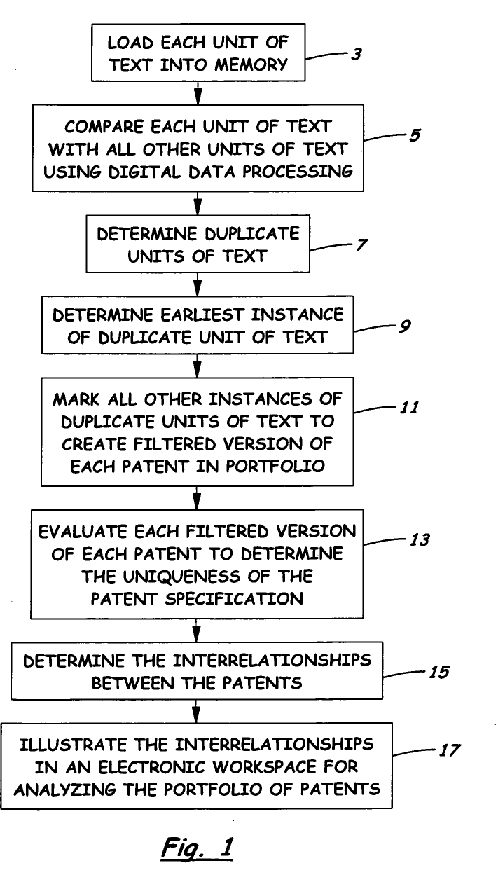

Referring now to FIG. 1, there is illustrated a flowchart demonstrating the filtering method for units of text according to the present invention. As shown in 3, each unit of text from a portfolio of patents is loaded into digital memory. The units of text can be paragraphs, sentences, phrases or words. The units of text are compared in 5 with all other units of text in memory using digital data processing. For example, the comparison may only look at the alphabetic characters in the text and ignore the numbers, punctuation, and spaces. Duplicate units of text are determined in 7. In a preferred embodiment, the duplicate units of text are determined by creating a table of pointers to all units of text generated based on length, in characters, of the unit of text. In order to expedite comparison, in a preferred embodiment only units of text of the same length are compared by measuring the similarity between the units of text using methods and means well known in the prior art. The earliest instance of the duplicate unit of text is determined in 9 and all instances of duplicate units of text other than the earliest instance is marked as duplicate in 11 in order to create a filtered version of each patent. The marking can be accomplished by replacing duplicate units of text with the patent number or application number of the earliest instance or each duplicate unit of text may be marked in some way, such as striking through the text. Striking through the duplicated text allows the user to easily read the duplicated text while enabling the user to quickly skip duplicate units of text.

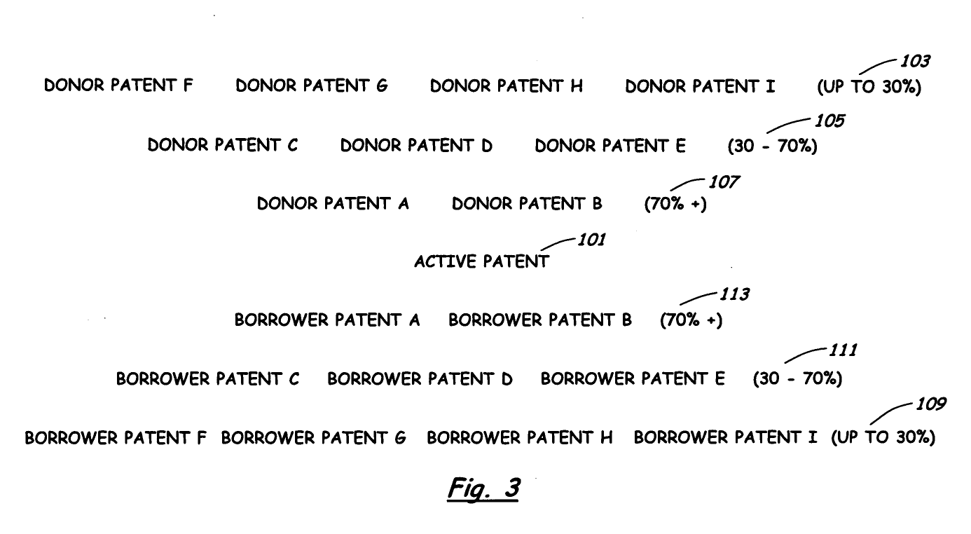

Each newly created filtered version of the patent is evaluated in 13 to determine the uniqueness of the patent specification. The filtered versions can be evaluated by determining the percentage of non-duplicated text, determining the percentage of text borrowed from other patents, by determining the number of patents that borrow text from a parent patent or any combination of these methods. The interrelationship between the patents is determined in 15. The interrelationships between the patents can be graphically displayed by listing the borrower patents at the bottom of the screen with the donor patents listed at the top of the screen and arranging the donors that contributed the most paragraphs to the borrower located nearest to the borrower. Alternatively, the borrowers can be arranged such that the borrowers that used the most paragraphs from the donor are located nearest to the donor. In the preferred embodiment, as shown in FIG. 3, a single active patent 101 is located at the narrowest point of the graphical display. The donor patents are arranged such that the donors that contributed the most paragraphs to the single active patent 101 are located nearest to the single active patent 101. As shown in FIG. 3, donor patents that contribute up to 30% of their paragraphs to the single active patent 101 are listed on level 103 of the graphical display farthest away from the single active patent 101. Donor patents that contribute 30-70% of their paragraphs to the single active patent 101 are listed on level 105 of the graphical display. Donor patents that contribute over 70% of their paragraphs to the single active patent 101 are listed on level 107 of the graphical display and are closest to the single active patent 101. In the same fashion, borrower patents that borrow up to 30% of their paragraphs from the single active patent 101 are listed on level 109 of the graphical display and are farthest away from the single active patent 101. Borrower patents that borrow 30-70% of their paragraphs from the single active patent 101 are listed on level 111 of the graphical display. Borrower patents that borrow over 70% of their paragraphs from the single active patent 101 are listed on level 113 and are closest to the single active patent 101. Each donor or borrower patent is a hyperlink to a new graphical display in which the selected donor or borrower patent becomes the new single active patent in the graphical display.

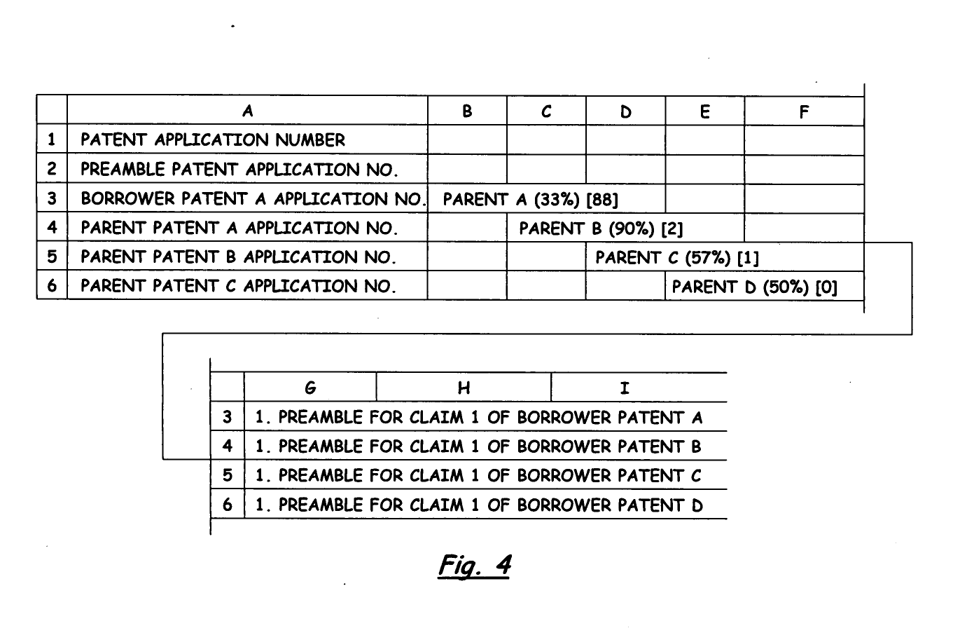

Finally, the interrelationships can be illustrated in an electronic workspace for analyzing the portfolio of patents in 17. One way to illustrate the interrelationships in an electronic workspace is to use hyperlinks to allow the user to click on an entry in a list of related patents to take the user to that patent. The duplicated sections of text are replaced with hyperlinks to patents with the same duplicated section of text. Additionally, as shown in FIG. 4, the lists of interrelated patents can be combined into a text file, which is then read into a spreadsheet to create a family tree for a parent patent application and its children. Column A Row 1 contains the patent application number being analyzed in the electronic workspace. Column A Row 2 contains the preamble of claim 1 for the patent application number being analyzed. Column A Row 3 contains the patent application number of Borrower Patent A, which borrows from the patent application listed in Column A Row 1. Column B Row 3 contains the patent number of the parent patent application of Borrower Patent A, shown as “Parent Patent A”, as well as the percentage of new text in the Parent Patent A is listed in parenthesis and the number of patents that borrow from Parent Patent A is listed in brackets. Parent Patent A is then listed in Column A Row 4. Column C Row 4 contains the parent patent application number of Parent Patent A, shown as “Parent Patent B”, as well as the percentage of new text in the Parent Patent B is listed in parenthesis and the number of patents that borrow from Parent Patent B is listed in brackets. Parent Patent B is then listed in Column A Row 5. Column D Row 5 contains the parent patent application number of Parent Patent B, shown as “Parent Patent C”, as well as the percentage of new text in the Parent Patent C is listed in parenthesis and the number of patents that borrow from Parent Patent C is listed in brackets. Parent Patent C is then listed in Column A Row 6. Column E Row 6 contains the parent patent application number of Parent Patent C, shown as “Parent Patent D”, as well as the percentage of new text in the Parent Patent D is listed in parenthesis and the number of patents that borrow from Parent Patent D is listed in brackets. Column G contains the preamble of claim 1 for each patent listed in Column A Rows 3-6.

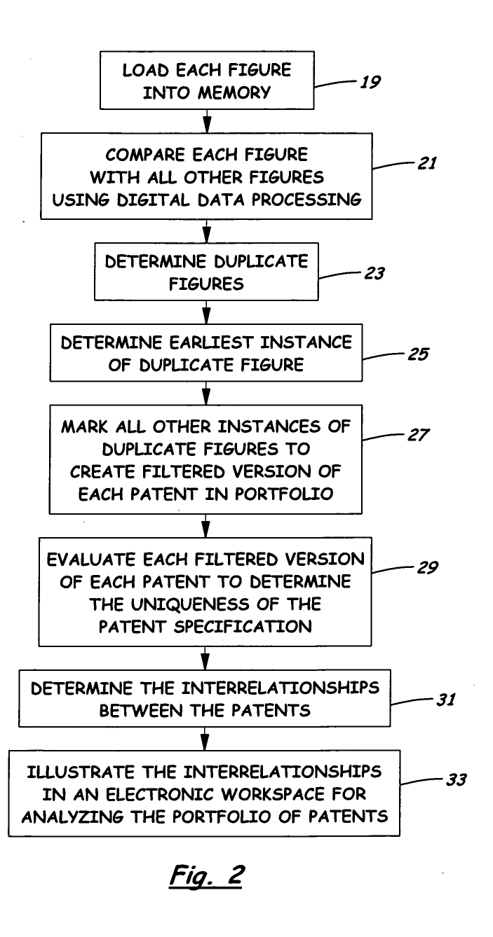

Referring now to FIG. 2, there is illustrated a flowchart demonstrating the filtering method for figures according to the present invention. As shown in 19, each figure from a portfolio of patents is loaded into digital memory. The figures are compared in 21 with all other figures in memory using digital data processing. Duplicate figures are determined in 23. The earliest instance of the duplicate figure is determined in 25 and all instances of duplicate figures other than the earliest instance is marked in 27 in order to create a filtered version of each patent. The marking can be accomplished by replacing duplicate figure with the patent number or application number of the earliest instance or each duplicate figure be marked in some way, such as striking through the duplicate figure. Striking through the duplicated figure allows the user to easily view the duplicated figure while enabling the user to quickly skip duplicate figures.

Each newly created filtered version of the patent is evaluated in 29 to determine the uniqueness of the patent specification. The filtered versions can be evaluated by determining the percentage of non-duplicated figures, determining the percentage of figures borrowed from other patents, by determining the number of patents that borrow figures from a parent patent or any combination of these methods. The interrelationship between the patents is determined in 31. The interrelationships between the patents can be graphically displayed by listing the borrower patents at the bottom of the screen with the donor patents listed at the top of the screen and arranging the donors that contributed the most paragraphs to the borrower located nearest to the borrower. Alternatively, the borrowers can be arranged such that the borrowers that used the most paragraphs from the donor are located nearest to the donor. In the preferred embodiment, as shown in FIG. 3, a single active patent 101 is located at the narrowest point of the graphical display. The donor patents are arranged such that the donors that contributed the most paragraphs to the single active patent 101 are located nearest to the single active patent 101. As shown in FIG. 3, donor patents that contribute up to 30% of the paragraphs to the single active patent 101 are listed on level 103 of the graphical display farthest away from the single active patent 101. Donor patents that contribute 30-70% of the paragraphs to the single active patent 101 are listed on level 105 of the graphical display. Donor patents that contribute over 70% of their paragraphs to the single active patent 101 are listed on level 107 of the graphical display and are closest to the single active patent 101. In the same fashion, borrower patents that borrow up to 30% of the paragraphs from the single active patent 101 are listed on level 109 of the graphical display and are farthest away from the single active patent 101. Borrower patents that borrow 30-70% of the paragraphs from the single active patent 101 are listed on level 111 of the graphical display. Borrower patents that borrow over 70% of the paragraphs from the single active patent 101 are listed on level 113 and are closest to the single active patent 101. Each donor or borrower patent is a hyperlink to a new graphical display in which the selected donor or borrower patent becomes the new single active patent in the graphical display.

Finally, the interrelationships can be illustrated in an electronic workspace for analyzing the portfolio of patents in 17. One way to illustrate the interrelationships in an electronic workspace is to use hyperlinks to allow the user to click on an entry in a list of related patents to take the user to that patent. The duplicated sections of text are replaced with hyperlinks to patents with the same duplicated section of text. Additionally, as shown in FIG. 4, the lists of interrelated patents can be combined into a text file, which is then read into a spreadsheet to create a family tree for a parent patent application and its children. Column A Row 1 contains the patent application number being analyzed in the electronic workspace. Column A Row 2 contains the preamble of claim 1 for the patent application number being analyzed. Column A Row 3 contains the patent application number of Borrower Patent A, which borrows from the patent application listed in Column A Row 1. Column B Row 3 contains the patent number of the parent patent application of Borrower Patent A, shown as “Parent Patent A”, as well as the percentage of new text in the Parent Patent A is listed in parenthesis and the number of patents that borrow from Parent Patent A is listed in brackets. Parent Patent A is then listed in Column A Row 4. Column C Row 4 contains the parent patent application number of Parent Patent A, shown as “Parent Patent B”, as well as the percentage of new text in the Parent Patent B is listed in parenthesis and the number of patents that borrow from Parent Patent B is listed in brackets. Parent Patent B is then listed in Column A Row 5. Column D Row 5 contains the parent patent application number of Parent Patent B, shown as “Parent Patent C”, as well as the percentage of new text in the Parent Patent C is listed in parenthesis and the number of patents that borrow from Parent Patent C is listed in brackets. Parent Patent C is then listed in Column A Row 6. Column E Row 6 contains the parent patent application number of Parent Patent C, shown as “Parent Patent D”, as well as the percentage of new text in the Parent Patent D is listed in parenthesis and the number of patents that borrow from Parent Patent D is listed in brackets. Column G contains the preamble of claim 1 for each patent listed in Column A Rows 3-6.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A filtering method for evaluating patents, comprising:
loading each unit of text in a portfolio of patents into digital memory;
comparing each unit of text with all other units of text in digital memory using digital data processing;
determining duplicate units of text;
determining earliest instance of each duplicate unit of text;
marking instances of duplicate unit of text other than earliest instance as duplicate.

2. The method of claim 1 further comprising creating a filtered version of each patent in a portfolio of patents.

3. The method of claim 2 further comprising evaluating each filtered version of each patent in a portfolio to determine the uniqueness of the patent specification.

4. The method of claim 1 further comprising determining the interrelationships between the patents in the portfolio and illustrating the interrelationships in an electronic workspace for analyzing the portfolio of patents.

5. The method of claim 1 wherein each unit of text is compared with every other unit of text by creating a table of pointers to all units of text generated based on length, in characters, of the units of text and only comparing units of texts of the same length.

6. The method of claim 5 wherein said units of text of the same length are compared by measuring the similarity between the units of text.

7. The method of claim 1 wherein said duplicate unit of texts are marked by replacing the duplicate unit of text with the reference number of the patent with the earliest instance of the duplicate unit of text.

8. The method of claim 1 wherein said duplicate unit of texts are marked by striking though the text of the duplicate unit of text.

9. The method of claim 1 wherein said filtered patents are evaluated for uniqueness by determining the percentage of non-duplicated text.

10. The method of claim 1 wherein said filtered patents are evaluated for uniqueness by determining the percentage of text that is borrowed from a parent patent.

11. The method of claim 2 wherein said filtered patents are evaluated for uniqueness by determining the number of patents that borrow text from a parent patent.

12. The method of claim 4 wherein determining said interrelationships between the patents in a portfolio comprises:
generating a list of related patents that borrow text from a parent patent; and
using the list to graphically represent how the patents in the list are related.

13. The method of claim 12 wherein said graphical representation is a family tree.

14. The method of claim 4 wherein said interrelationships between the patent in a portfolio are illustrated in an electronic workspace for analyzing the portfolio of patents by using hyperlinks in an electronic document to allow the user to click on an entry in a list of related patents to take the user to that electronic patent document.

15. The method of claim 14 wherein said list of related patents are combined into a text file and are read into an electronic spreadsheet.

16. The method of claim 1 wherein said unit of texts are selected from the group consisting of paragraphs, sentences, phrases or words.

17. The method of claim 16 wherein only the alphabetic characters in said units of texts are compared.

18. A filtering method for evaluating patents, comprising:
loading each figure in a portfolio of patents into digital memory;
comparing each figure with all other figures in digital memory using digital data processing;
determining duplicate figures;
determining earliest instance of each duplicate figure;
marking instances of duplicate figure other than earliest instance as duplicate.

19. The method of claim 18 further comprising creating a filtered version of each patent in a portfolio of patents.

20. The method of claim 18 further comprising
loading each unit of text in the portfolio into the digital memory;
comparing each unit of text with all other units of text in digital memory using digital data processing;
determining duplicate units of text;
determining earliest instance of each duplicate unit of text;
marking instances of duplicate unit of text other than earliest instance as duplicate.
